(19) United States
(12) Patent Application Publication
(10) Pub. No.: US 2003/0037642 A1
(43) Pub. Date: Feb. 27, 2003

(54) Wrench structure

(76) Inventor: Lin-Lang Liu, Taipei City (TW)

Correspondence Address: Lin-Lang, Liu, PO Box 82-144, TAIPEI, TW

(21) Appl. No.: 09/934,673

(22) Filed: Aug. 23, 2001

(51) Int. Cl. B25B 13/46

(52) U.S. Cl. 81/60

(57) ABSTRACT

An improved structure of the wrench is disclosed. The wrench relates generally to the end of the handle is mounted with an open jaw module. The open jaw module has an end protrusion of the handle relatively provided with a smaller path of an insert lever, and an open jaw is mounted. The end of the open jaw is relatively formed into an insert recess of the insert lever. In accordance with the above mentioned for the specific structure design, the user will depend on his requirements to change for the difference standard of the open jaw.

### BACKGROUND OF THE INVENTION

(1) Field of the Invention

The present invention relates to a wrench, and in particular, a wrench can be used with different standard open wrench as to release the load of carrying, reduce cost and increase its economy efficiency.

(2) Description of the Prior Art

Accordingly, a wrench relates generally to a tool used for dismantling studs or nuts. It comprises an open type, a hexagon type and a sleeve type. The difference standards and combinations will solely depend on studs and nuts sizes as shown in FIG. 1. The wrench has one end of the handle 10 formed into an open ended 15. The other end of the handle 10 is mounted with a ratchet sleeve module 20, and a sleeve 21 is provided. The external edge of the sleeve 21 can cap a stud or a nut forms into a ratchet face 22. The handle 10 relative to one internal edge of the ratchet sleeve 20 is provided with a retainer 23 with which has placed into a smaller ratchet block 24. Behind the ratchet block 24 is supported with a spring element 25. When the wrench is turning in clockwise direction, the highest point of the ratchet block 24 can engage with the ratchet face 22 of the sleeve 21 so that the sleeve 21 can turn the stud or the nut. Otherwise, when the wrench is in the reverse turning; the ratchet face 22 of the sleeve 21 will push the ratchet block 24 move towards to a slightly larger side of the retainer 23 so that the sleeve 21 will not be restricted by the ratchet block 24 and it becomes an empty turning. Thus, it is convenience in operation for the user. However, the application for the conventional wrench as above mentioned currently having the following problem and worry:

(a). Commonly Use Being Poor

The current wrench whether it relates to the open ended 15 or the sleeve 21 its size standard is fixed, it is unable to make any change. Therefore, the user must carry with number of modules and difference standard of the wrench in application. It will increase the expenses and the load of the user. Moreover, if any one end of the wrench is damaged it is required to change a new one.

(b). Lesser Torsion Force

The current ratchet block 24 is engaged with a ratchet face 22 of the sleeve 21 which is being restricted by an arc protrusion design of the ratchet block 24. Whenever the wrench is turning, the sleeve 21 and the ratchet block 24 can only provide a single engagement. It is very obviously that its torque is not strong enough which always make the ratchet face 22 or the ratchet block 24 damaged, and will increase the frequency of repairing and changing.

### SUMMARY OF THE INVENTION

Accordingly, it is an object of the present invention to provide the following technical means to achieve the above-mentioned purpose. The wrench has two ends of the handle being separately mounted with an open jaw module and a sleeve module; wherein: the open jaw module has the end protrusion of the handle relatively provided with a smaller path of an insert lever, and an open jaw is mounted. The end of the open jaw is relatively formed into an insert recess of the insert lever.

The sleeve module has another end of the handle to form into a collar. The internal diameter of the bottom edge protrusion of the collar has a set of the resist edge. The collar is provided with the resist edge to be placed in is mounted with an external circumference of the ratchet face of the sleeve. The handle is corresponding to the internal diameter of the collar formed into a joint to the crescent recess. Behind the crescent recess is also extended with a retainer; and the crescent recess is mounted within a crescent ratchet block. The crescent ratchet block is corresponding to the engaging gear and the curving of the ratchet face. The crescent ratchet block and the bottom edge of the retainer are secured with a recovery spring. Therefore, the user will depend on his requirement for changing the appropriate standard of the open jaw or the sleeve. Further, it can improve its sleeve torque and reduce its damages.

These and other advantages of the present invention will become clear to those skilled in the art upon a study of the detailed description of the invention and of the several figures of the drawings.

### BRIEF DESCRIPTION OF THE DRAWINGS

FIG. 1 is the plan view of the conventional wrench.

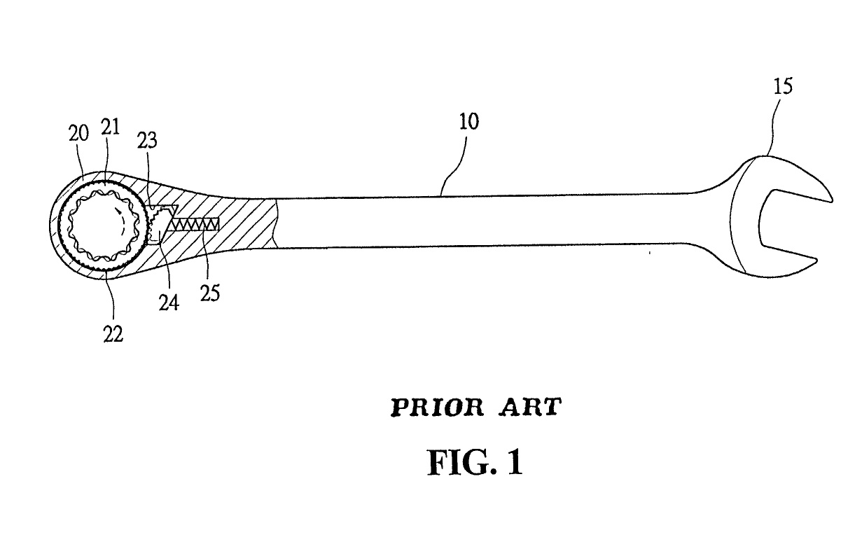

FIG. 2 is the perspective exploded view showing the components and its related relation of the present invention.

FIG. 3 is the (A) side and (B) partial front view showing the replacement for the open jaw or the sleeve.

FIG. 4 is the partial front view showing the ratchet sleeve movement of the present invention.

FIG. 5 is one of the preferred embodiment perspective exploded view of the present invention.

FIG. 6 is another preferred embodiment perspective exploded view of the present invention.

### DETAILED DESCRIPTION OF THE PRESENT INVENTION

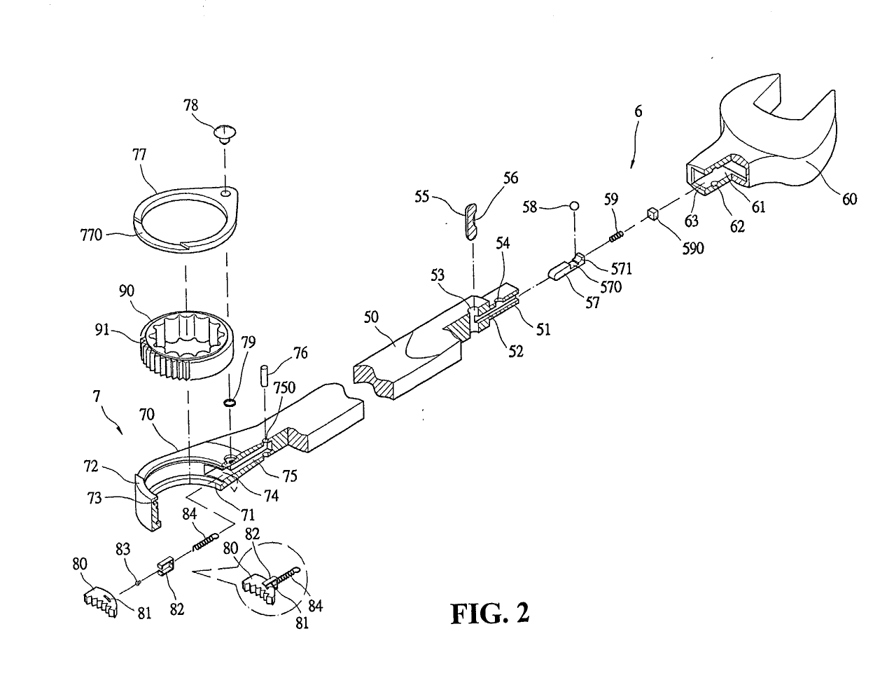

The present invention relates generally to an improved structure of a wrench that can increase its application scope and improve its torque, as shown in FIG. 2. The wrench has two ends of the handle being separately mounted with an open jaw module 6 and a sleeve module 7; wherein the open jaw module 6 and the sleeve module 7 are changeable for the difference size standard of wrench.

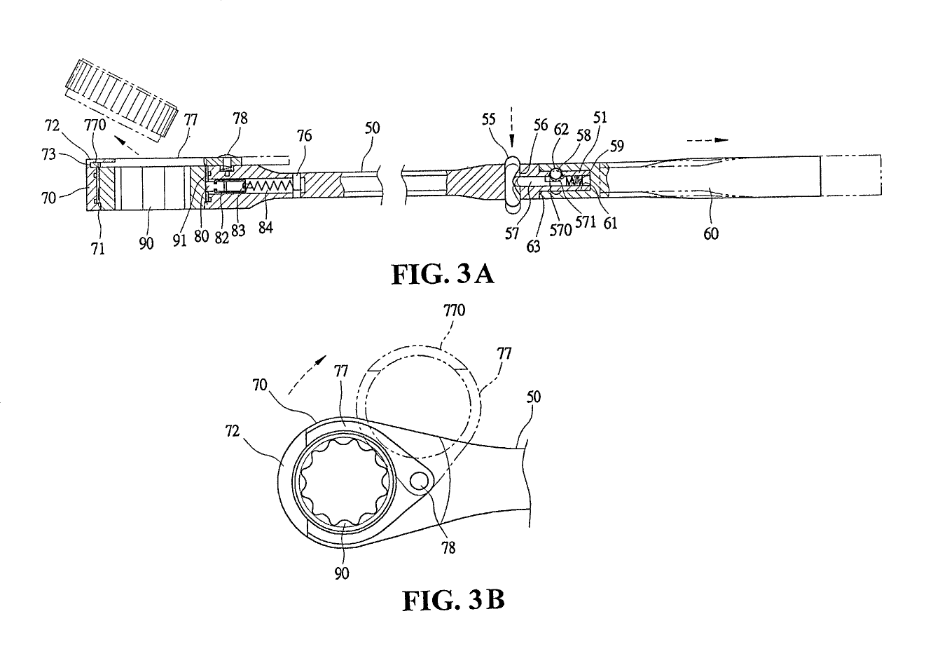

The open jaw module 6 has the end protrusion of the handle 50 relatively provided with a smaller path of an insert lever 51. The handle 50 at the center along the axis of the insert lever 51, a slip recess 52 is provided to slide with a supporting block 57. The insert lever 51 relative to the slip recess 52 forms into a joint to the through hole 54. The handle 50 is corresponding to the internal edge of the slip recess 52 formed into a path thoroughly pass towards to an insert hole 53. The insert hole 53 is slippery mounted with a position tap 55. The position tap 55 is corresponding to the external edge of the slip recess 52 formed into a semi sphere of an urging recess 56, and the arc protrusion edge of the supporting block 57 is relatively put into the urging recess 56. The supporting block 57 relative to the through hole 54 forms into a give way recess 570. The give way recess 570 is different from the lateral side of the position tap 55 formed into an enlarging slant 571. The give way recess 570 is provided with a position steel ball 58 has a slightly protrusion through hole 54. The radius of the position steel ball 58 is slightly smaller than the through hole 54 being restricted as not to drop. The supporting block 57 is corresponding to another end support of the slip recess 52 has a recovery element 59, and a confined block 590 is fastened with the open ended of the slip recess 52. The supporting block 57 is restricted within the slip recess 52 and is forced to move as shown in FIG. 3A.

The insert lever 51 is provided with an open jaw 60 which has a difference size standard. At the end of the open jaw 60, an insert recess 61 is provided for inserting of the insert lever 51. The internal edge of the insert recess 61 is corresponding to the insert lever 51 of the position steel ball 58 formed into a position recess 62 (As shown in FIG. 3A) as to improve the clutch locked with its union force for the open jaw 60 and the handle 50. The open circumference of the insert recess 61 is separately formed into a slanting guiding edge 63 for inserting of the insert lever 51.

As above-mentioned, the structures of the handle 50, the insert lever 51 and the insert recess 61 of the open jaw 60 are interchangeable and achievable the same outcome.

The sleeve module 7 relates to an end of the handle 50, a collar 70 is provided. The collar 70 is pivotally mounted with a confined plate 77 has a smaller internal diameter. The internal diameter of the bottom end protrusion of the collar 70 has a set of the resist edge 71 which is relatively fastened with a sleeve 90. The top face end upward protrusion of the collar 70 has a press block 72 of the groove 73. Furthermore, the handle 50 relative to the internal diameter of the collar 70 forms into a joint to the crescent recess 74, and a crescent ratchet block 80 is provided. Behind the crescent recess 74 is extended with a retainer 75. The handle 50 relative to the bottom edge of the retainer 75 forms into a path towards a joint to the thorough hole 750 as to provide a securing peg 76 for inserting. The confined plate 77 has a pivot peg 78 and spring 79 pivotally mounted with the handle 50 is corresponding to the collar 70 for pivotal turning (As shown in FIG. 3B). The free end of the confined plate 77, a collar 70 is provided which can insert with a protrusion clutch 770 of the groove 73 (As shown in FIG. 3 A).

Both sides of the crescent ratchet block are mounted with the crescent recess 74 is relatively formed into a slip recess 81. The slip recess 81 can slip locked with a C shape clamp block 82. The clamp block 82 has a clamp peg 83 fastened with a spring 84. The other end of the spring 84 has a securing peg 76 fastened with the bottom edge of a retainer 75 so that the crescent ratchet block 80 can produce an automatic recovery function. The internal diameter of the sleeve 90 is mounted in with the collar 70 can be varied with difference standard. The external circumference of the sleeve 90, a ratchet face 91 is provided. The ratchet face 91 is corresponding to the engaging gear and the curving of the crescent ratchet block 80 so that the crescent ratchet block 80 can totally engage on the ratchet face 91 of the sleeve 90. Thus, this module is forming a commonly used being good and increasing in torsion for the wrench structure method.

According to the above specific structure design; the present invention when it is in practical application is in FIGS. 3 A & B. When a user requires changing difference size of the open jaw 60 it only requires to press the position peg 55 on the handle 50 so that the position peg 55 will push the supporting block 57 with the rise of the internal edge of the urging recess 56. Further, the position steel ball 58 will fall inside the give way recess 570 of the supporting block 57 then it can pull out the open jaw 60 smoothly. When the user opens the position peg 55 the supporting block 57 will be reverted back in accordance with the function of the recovery element 59. Meanwhile, with the function of the slant 571 and the arc edge of the give way recess 570 it will push the position steel ball 58 and the position peg 55 back to its origin position. Again it continues for the new open jaw 60 with the insert recess 61 will cap on the insert lever 51. When the guiding edge 63 hits on the position steel ball 58 and with the slanting relation it will press down the position steel ball 58 so that the open jaw 60 will continue pull in until the position steel ball 58 is corresponding to the position recess 62. The position steel ball 58 will be reverted with the function of the recovery element 59 so that the open jaw can steady mount on the handle 50 in order to achieve the purpose of changing for difference size standard and increasing its commonly used.

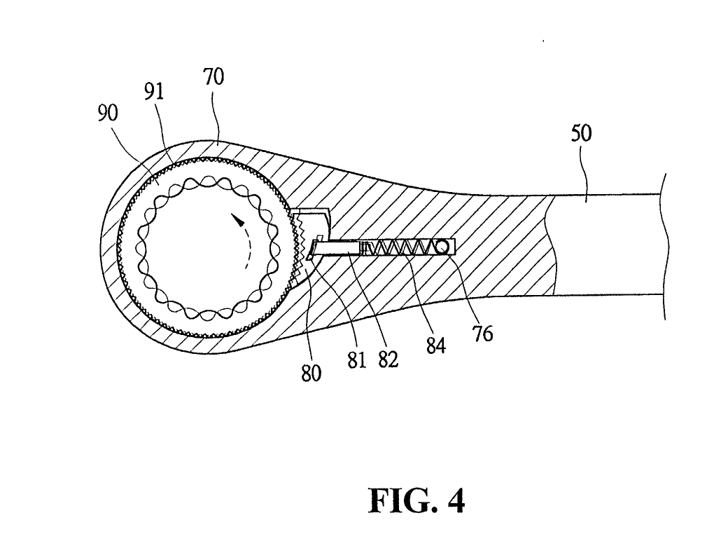

The sleeve module 7 can be changeable is shown in FIGS. 3 & 4. When the user requires changing for the difference size of the sleeve 90, he only needs to turn one side of the confined plate 77 and then take out the sleeve 90. The new sleeve 90 will be placed into the collar 70 again so that the ratchet face 91 of the sleeve 90 will engage with the crescent ratchet block 80. The confined plate 77 will be pulled back to its origin position in the end. The protrusion clutch 770 will engage with the groove 73. Thus, it can rapidly change for difference size standard of the sleeve 90. When the user is turning the stud or the nut with the sleeve module 7 in clockwise direction, the ratchet face 91 of the sleeve 90 will let the crescent ratchet block 80 move upwards so that all gears of the crescent ratchet block 80 can totally engage with the ratchet face 91 of the sleeve 90. While it is in turning it can receive a larger torsion. Otherwise, when the user is turning in anti-clockwise direction the crescent ratchet block 80 is push by the ratchet face 91 of the sleeve 90 and is slightly out of orbit so that the sleeve 90 will become an empty turning. As this is convenience in operation for the user to turn and off turn his wrench. Meanwhile, on the crescent ratchet block 80, a slip recess 81 is provided so that the slip motion of the crescent ratchet block 80 can be accomplished. Therefore, the clamp block 82 and the spring 84 do not require any movement so that the retainer 75 can be designed in a smaller of the internal diameter (As shown in FIG. 4) as it is effectively increased the strength of the handle 50.

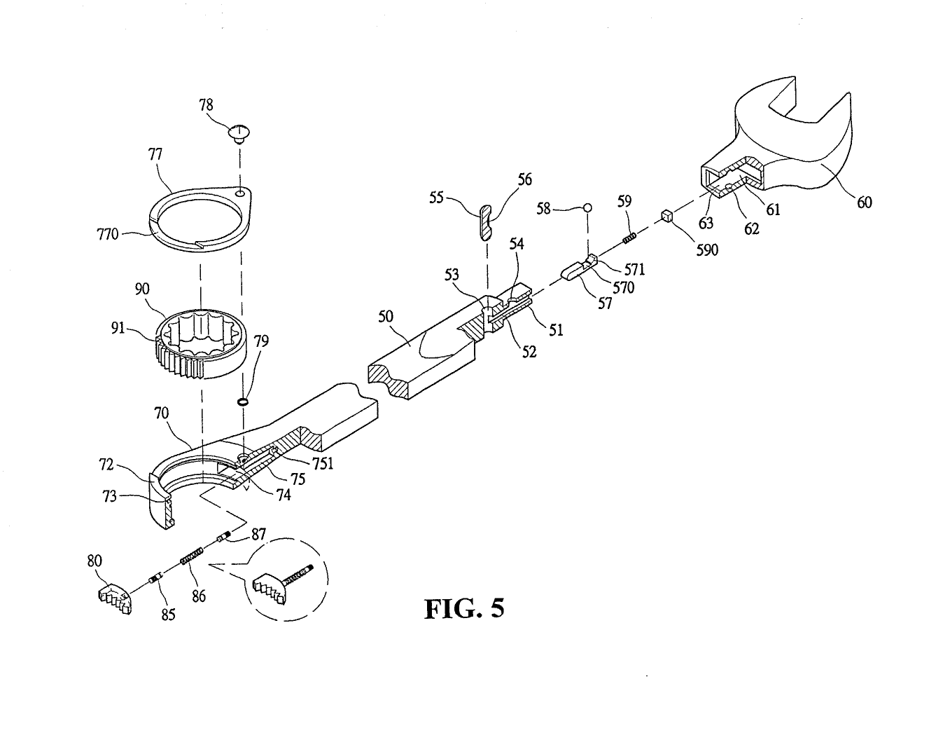

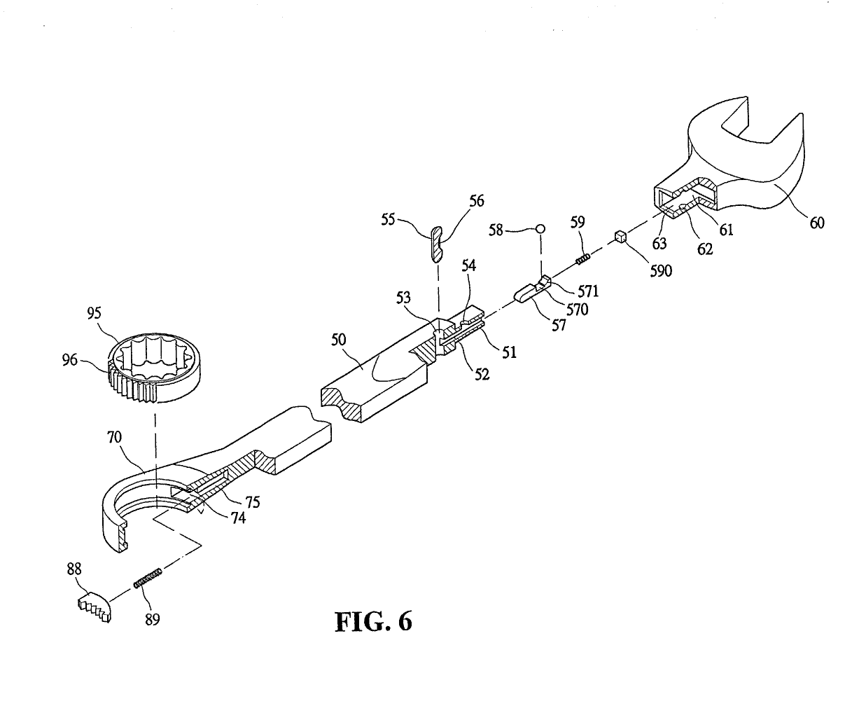

Moreover, the present invention being provided with one of the preferred embodiments as shown in FIG. 5, wherein the crescent ratchet block 80 has a securing peg 85 fastened at its bottom, and which a spring 86 is mounted, and the other end of the spring 86 is mounted with a securing peg 87. The bottom end of the retainer 75 of the handle 50, a peg hole 751 is provided so that the securing peg 87 can mount at the bottom end of the retainer. Thus, the crescent ratchet block 80 can mount inside the crescent recess 74 in conjunction with the driven from the clockwise and the anti-clockwise turning of the sleeve 90. The present invention being provided with another preferred embodiments as shown in FIG. 6. The sleeve module 7 having being designed for non changeable type; wherein the crescent ratchet block 88 will be placed into the crescent recess 74 of the handle 50. Behind the crescent ratchet block 88 of the retainer 75 is supported with a spring 89 that is provided for the recovery action. The external edge of the ratchet face 96 of the sleeve 90 is mounted within the collar 70 of the handle 50, and the crescent ratchet block 88 is corresponding to the curving and the engaging gear of the ratchet face 96. When the wrench is turning in clockwise direction the crescent ratchet block 88 can totally engage with the ratchet face 96 of the sleeve 90 so it is effectively raise its torque.

Meantime, the present invention provides the following with further advantages and practical values:

(1). Commonly Use Being Good

Through the present invention specific design, wherein the open jaw 60 of the sleeve 90 will depend on the user requirement. It can change for a new one any time and the replacing action is very convenience. If compare with the conventional for the fixed size the present invention can really improve it commonly used efficiency.

(2). Good Torque

Due to the crescent ratchet block 80 specific design when the wrench is in turning, the crescent ratchet block 80 will let all gears being engaged with the ratchet face 91 of the sleeve 90. If compare with the conventional method it can only be engaged with one or two gears so the present invention can effectively increase it engaging power, rise it overall torsion and it does not cause damage easily.

(3). Cost Being Low

As mentioned before, the present invention for the open jaw 60 and the sleeve 90 will depend on the user requirement. In application, the user is only required to carry a piece of the handle and then in conjunction with a series of smaller volume for the open jaw 60 and the sleeve 90. Thus, it effectively releases the load of the user and reduces the purchasing cost, and it also reduces the repairing expenses because of the good engagement and does not damage easily. Even with the damages of the open jaw 60 or the sleeve 90 it only requires to replace those damage parts.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only the scope of the appended claims.

I claim:

1. An improved structure of a wrench having a handle at least one end being mounted with an open jaw module, wherein; the open jaw module has the end protrusion of the handle relatively provided with a smaller path of the insert lever, and an open jaw is mounted, the end of the open jaw is relatively formed into an insert recess of the insert lever.

2. The improved structure of a wrench as claimed in claim 1, wherein the handle at the center along the axis of the insert lever, a slip recess is provided to slide with a supporting block, and he top face of the insert lever forms into a joint to the through hole of the slip recess, and the handle forms into a path thoroughly pass towards a joint of the through hole of the slip recess, and the through hole is mounted within a position peg of an urging recess, and the supporting block is corresponding to the one end of the urging recess formed into an arc, and relative to the through hole, a slanting give way recess is provided, and the give way recess being mounted within an external diameter which is slightly smaller than the through hole, and is slightly protruded out of the through hole for the position steel ball, the supporting block is corresponding to another end support of the slip recess has a recovery spring and a confined plate fastened at the opening of the slip recess, the internal edge of the insert recess of the open jaw relative to the position steel ball of the insert lever, a position recess is provided.

3. The improved structure of a wrench as claimed in claim 1, wherein the open circumference of the insert recess for the open jaw is separately formed into a slanting guiding edge to facilitate the handle to be inserted into the insert lever.

4. A improved structure of a wrench relating generally to both ends of the handle having being separately mounted with an open jaw module and a sleeve module, wherein the open module has an end protrusion of the handle relatively provided with a smaller path of the insert lever, and an open jaw is mounted, the end of the open jaw is relatively formed into an insert recess of the insert lever, the sleeve module having another end of the handle forms into a collar, the internal diameter of the bottom end protrusion of the collar has a set of the resist edge, and the resist edge is provided with the collar to be placed in is mounted with an external circumference of the ratchet face of the sleeve, the handle is relative to the internal diameter of the collar formed into a joint to the crescent recess, and behind the crescent recess is also extended with a retainer, and the crescent recess is mounted within a crescent ratchet block, and the crescent ratchet block is corresponding to the engaging gear and the curving of the ratchet face, and the crescent ratchet block and the bottom end of the retainer are mounted with a recovery spring.

5. The improved structure of a wrench as claimed in claim 4; wherein the handle at the center along the axis of the insert lever, a slip recess is provided to slide with a supporting block. The top face of the insert lever forms into a joint to the through hole of the slip recess, and the handle is formed into a path thoroughly pass towards a joint of the through hole of the slip recess, and the through hole is mounted within a position peg of an urging recess, and the supporting block is corresponding to the one end of the urging recess formed into an arc, and relative to the through hole, a slanting give way recess is provided, and the give way recess being mounted within an external diameter which is slightly smaller than the through hole, and is slightly protruded out of the through hole for the position steel ball, and the supporting block is corresponding to another end support of the slip recess has a recovery spring and a confined plate fastened at the opening of the slip recess, and the internal edge of the insert recess of the open jaw relative to the position steel ball of the insert lever, a position recess is provided.

6. The improved structure of a wrench as claimed in claim 4, wherein the open circumference of the insert recess for the open jaw is separately formed into a slanting guiding edge so that it is convenience for the handle to insert the insert lever.

7. The improved structure of a wrench as claimed in claim 4, wherein the collar of the sleeve, a pivot tap and a spring are pivotally mounted with a smaller diameter of a confined plate, and the free end of the confined plate, a protrusion clutch is provided, and the top face end upward protrusion of the collar has a press block of the groove so that the confined plate can insert into the groove of the collar.

8. The improved structure of a wrench as claimed in claim 4, wherein both sides of the crescent ratchet block of the sleeve module is relatively formed into a slip recess, and the slip recess can provide a slip locked with a C shape clamp block, and the clamp block has a clamp peg is fastened with a spring, and the handle is corresponding to the bottom end of a retainer formed into a path towards to a joint to a thorough hole with which having a securing peg is mounted with the other end of the spring.

9. The improved structure of a wrench as claimed in claim 4, wherein the bottom of the crescent ratchet block of the sleeve module has a securing peg fastened with the end of a spring, and the bottom of a retainer, a peg hole is provided so that the securing peg is fastened with another end of the spring.

10. An improved structure of a wrench relating generally to both ends of the handle having being separately mounted with an open jaw module and a sleeve module, wherein, the open module has an end protrusion of the handle relatively provided with a smaller path of the insert lever, and an open jaw is mounted, and the end of the open jaw is relatively formed into an insert recess of the insert lever, and the sleeve module having the another end of the handle forms into a collar, and the internal diameter of the bottom end protrusion of the collar has a set of the resist edge, and the resist edge is provided with the collar to be placed in is mounted with an external circumference of the ratchet face of the sleeve, and the handle is relative to the internal diameter of the collar formed a joint to the crescent recess, and behind the crescent recess is also extended with a retainer, and the crescent recess is mounted within a crescent ratchet block, and the crescent ratchet block is corresponding to the engaging gear and the curving of the ratchet face, and the crescent ratchet block and the bottom end of the retainer are mounted with a recovery spring.

11. The improved structure of a wrench as claimed in claim 10; wherein the handle at the center along the axis of the insert lever, a slip recess is provided to slide with a supporting block, and the top face of the insert lever forms into a joint to the through hole of the slip recess. On the handle forms into a path thoroughly pass towards a joint of the through hole of the slip recess, and the through hole is mounted within a position peg of an urging recess, and the supporting block is corresponding to the one end of the urging recess formed into an arc, and relative to the through hole, a slanting give way recess is provided, and the give way recess being mounted within an external diameter which is slightly smaller than the through hole, and is slightly protruded out of the through hole for the position steel ball, and the supporting block is corresponding to another end support of the slip recess has a recovery spring and a confined plate fastened at the opening of the slip recess, and the internal edge of the insert recess of the open jaw relative to the position steel ball of the insert lever, a position recess is provided.

12. The improved structure of a wrench as claimed in claim 10, wherein the open circumference of the insert recess for the open jaw is separately formed into a slanting guiding edge to expedite the handle to be inserted into the insert lever.

13. An improved structure as claimed in claim 10, wherein, the open module has an end protrusion of the handle relatively provided with a smaller path of the insert lever, and an open jaw is mounted, and the end of the open jaw is relatively formed into an insert recess of the insert lever, and the sleeve module having another end of the handle forms into a collar, and the internal diameter of the bottom end protrusion of the collar has a set of the resist edge, and the resist edge is provided with the collar to be placed in is mounted with an external circumference of the ratchet face of the sleeve, and the handle is relative to the internal diameter of the collar formed into a joint to the crescent recess. Behind the crescent recess is also extended with a retainer, and the crescent recess is mounted within a crescent ratchet block, and the crescent ratchet block is corresponding to the engaging gear and the curving of the ratchet face, and the crescent ratchet block and the bottom end of the retainer are mounted with a recovery spring.

14. The improved structure of a wrench as claimed in claim 13, wherein the collar of the sleeve, a pivot peg and a spring are pivotally mounted with a smaller diameter of a confined plate, and the free end of the confined plate, a protrusion clutch is provided, and the top face end upward protrusion of the collar has a press block of the groove so that the confined plate can insert into the groove of the collar.

15. The improved structure of a wrench as claimed in claim 13, wherein both sides of the crescent ratchet block of the sleeve module is relatively formed into a slip recess, and the slip recess can provide a slip locked with a C shape clamp block, and the clamp block having a clamp peg is fastened with a spring, and the handle is corresponding to the bottom end of a retainer formed into a path towards to a joint to a thorough hole with which has a securing peg mounted with the other end of the spring.

16. The improved structure of a wrench as claimed in claim 13, wherein the bottom of the crescent ratchet block of the sleeve module has a securing peg fastened with the end of a spring, and the bottom of a retainer, a peg hole is provided so that the securing peg is fastened with another end of the spring.

17. The improved structure of a wrench as claimed in claim 13, wherein the sleeve module having another end of the handle forms into a collar, and the internal diameter of the bottom end protrusion of the collar has a set of the resist edge, and the resist edge is provided with the collar to be placed in is mounted with an external circumference of the ratchet face of the sleeve, and the handle is relative to the internal diameter of the collar formed into a joint to the crescent recess, and behind the crescent recess is also extended with a retainer, and the crescent recess is mounted within a crescent ratchet block, and the crescent ratchet block is corresponding to the engaging gear and the curving of the ratchet face, and the crescent ratchet block and the bottom end of the retainer are mounted with a recovery spring.
